(19) United States
(12) Patent Application Publication
(10) Pub. No.: US 2009/0189441 A1
(43) Pub. Date: Jul. 30, 2009

(54) Distributed electrical/electronic architectures for brake-by-wire brake systems

(76) Inventors: Paul Degoul, Paris (FR); Robert J. Disser, Dayton, OH (US)

Correspondence Address: DELPHI TECHNOLOGIES, INC., M/C 480-410-202, PO BOX 5052, TROY, MI, 48007, US

(21) Appl. No.: 12/011,662

(22) Filed: Jan. 29, 2008

(51) Int. Cl. B60T 13/66; B60T 8/78

(52) U.S. Cl. 303/199; 303/3; 303/113.4

(57) ABSTRACT

A brake system including a communication bus, a sensor including an integral star coupler, the star coupler being in communication with the communication bus, wherein the sensor generates a sensor signal, a first electronic control unit directly connected to the sensor to directly receive the sensor signal, the first electronic control unit being in communication with the communication bus, and a second electronic control unit in communication with the communication bus, wherein the second electronic control unit receives the sensor signal over the communication bus by way of the star coupler.

### BACKGROUND

The present application is directed to brake-by-wire brake systems and, more particularly, to distributed E/E (electrical/electronic) architectures for brake-by-wire brake systems.

Brake-by-wire brake systems have been developed to replace the traditional hydraulic connection between the brake pedal and the braking devices with electrical connections. Brake-by-wire brake systems typically employ a traditional pedal connected to a pedal feel emulator adapted to simulate the feel of a traditional hydraulic brake system, while generating signals indicative of the driver's braking intent.

Typically, a single electronic control unit having multiple internal redundancies is used to convert the driver's braking intent, as determined by various sensors (e.g., position and/or force sensors), into command signals that are electronically communicated to the braking devices as electrical signals. The multiple redundancies ensure safe operation of the brake-by-wire system in the event of a fault in one or more of the internal components of the electronic control unit. This electronic control unit is fault-tolerant. However, such single electronic control units often are complex and expensive to manufacture and install.

Accordingly, there is a need for a safe and low cost system and method for controlling braking devices in response to driver inputs in brake-by-wire brake systems.

### SUMMARY

In one aspect, a brake system may include a communication bus, a sensor including an integral star coupler, the star coupler being in communication with the communication bus, wherein the sensor generates a sensor signal, a first electronic control unit directly connected to the sensor to receive the sensor signal, the first electronic control unit being in communication with the communication bus, and a second electronic control unit in communication with the communication bus, wherein the second electronic control unit receives the sensor signal over the communication bus by way of the star coupler.

In another aspect, a brake system may include a communication bus, the communication bus including at least a first channel and a second channel, a first brake pedal sensor including an integral star coupler, the star coupler being in communication with the communication bus by way of the first channel, wherein the first sensor generates a first sensor signal, a second brake pedal sensor including an integral star coupler, the star coupler being in communication with the communication bus by way of the second channel, wherein the second sensor generates a second sensor signal, a first electronic control unit directly connected to the first sensor to receive the first sensor signal, the first electronic control unit being in communication with the first and second channels of the communication bus, and a second electronic control unit directly connected to the second sensor to received the second sensor signal, the second electronic control unit being in communication with the first and second channels of the communication bus, wherein the first electronic control unit receives the second sensor signal over the first channel by way of the first star coupler and the second channel by way of the second star coupler and wherein the second electronic control unit receives the first sensor signal over the first channel by way of the first star coupler and the second channel by way of the second star coupler.

In another aspect, a brake system may include a communication bus, the communication bus including at least a first channel and a second channel, a plurality of electronic control units, each of the electronic control units being in communication with the communication bus by way of the first channel and/or the second channel, and a plurality of brake pedal sensors, at least one of the brake pedal sensors being in direct communication with at least one of the electronic control units.

Other aspects of the disclosed distributed E/E architectures for brake-by-wire brake systems will become apparent from the following description, the accompanying drawings and the appended claims.

### BRIEF DESCRIPTION OF THE DRAWINGS

FIG. 1 is a block diagram of a brake-by-wire brake system according to one aspect of the disclosed distributed E/E architectures for brake-by-wire brake systems;

FIG. 2 is a block diagram of a brake pedal assembly of the brake-by-wire brake system of FIG. 1; and

FIG. 3 is a block diagram of a brake pedal sensor of the brake-by-wire brake system of FIG. 1.

### DETAILED DESCRIPTION

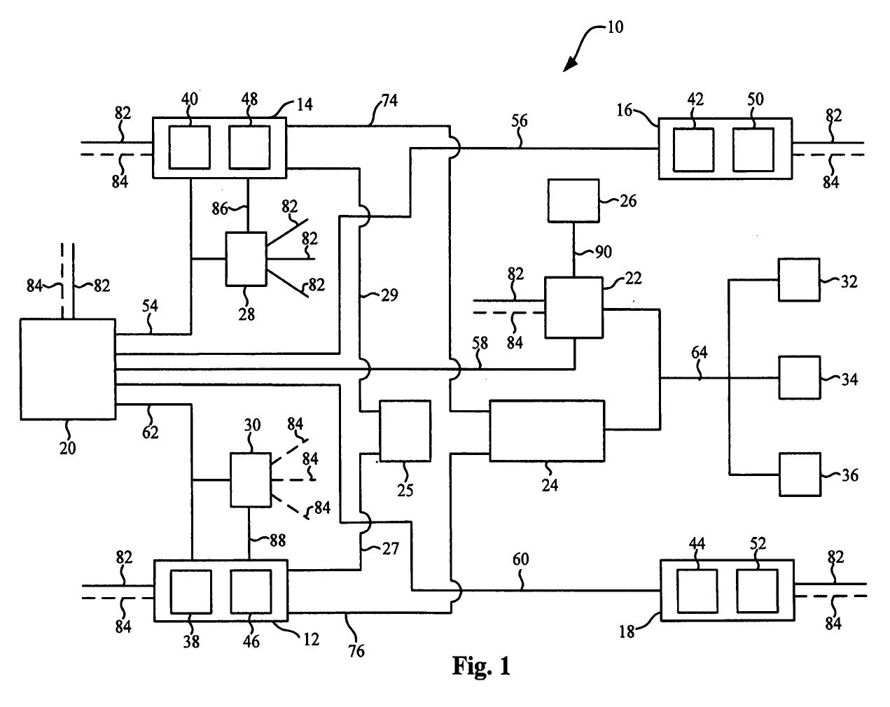

In FIG. 1 there is shown a brake-by-wire brake system, generally designated 10, according to one aspect of the disclosed distributed E/E architectures for brake-by-wire brake systems. The system 10 may include a left-front corner brake module 12, a right-front corner brake module 14, a right-rear corner brake module 16, a left-rear corner brake module 18, a power distribution box 20, a supervisory electronic control unit 22, a brake switch 24, a park brake switch 25, brake pedal sensors 26, 28, 30 and brake lights 32, 34, 36.

Each of the corner brake modules 12, 14, 16, 18 may include an associated braking device 38, 40, 42, 44 and associated control electronics 46, 48, 50, 52. The control electronics 46, 48, 50, 52 may be integrated into the braking devices 38, 40, 42, 44 or localized in the general area of the associated braking devices 38, 40, 42, 44 as separate electronic control units. The braking devices 38, 40, 42, 44 may be electric devices, electro-mechanical devices or the like. The corner brake modules 12, 14, 16, 18 may implement foundation brake function and, more generally, may implement all brake and brake-related functions, such as dynamic rear proportioning, the anti-lock braking system, the traction control system and vehicle stability enhancement.

The power distribution box 20 may be a fault-tolerant power network and may distribute electrical power to the right-front module 14 and sensor 28 over line 54, to the right-rear module 16 over line 56, to the left-rear module 18 over line 60 and to the left-front module 12 and sensor 30 over line 62. The supervisory electronic control unit 22 may receive power from the power distribution box 20 over line 58 or, alternatively, may be directly powered by the vehicle battery (not shown). The power distribution box 20 may include control electronics (e.g., an electronic control unit) and may selectively apply electrical power to lines 54, 56, 58, 60, 62 to selectively isolate components of the system 10 that are malfunctioning, thereby allowing the system 10 to continue to operate despite one or more malfunctions in the system.

At this point, those skilled in the art will appreciate that power distribution box 20 is an optional component and the system 10 may be powered using any available means. For example, the right-front module 14, sensor 28, right-rear module 16, vehicle dynamics module 22, left-rear module 18, left-front module 12 and sensor 30 may each be directly connected to one or more batteries (not shown) or other power sources.

The supervisory electronic control unit 22 may compliment the corner brake modules 12, 14, 16, 18 and may implement high-level braking functions, such as an anti-lock braking system, a traction control system, an electronic stability control system or other vehicle functions. In one aspect, the supervisory electronic control unit 22 may be a vehicle dynamics module, as is well known in the art. Optionally, the supervisory electronic control unit 22 may be connected to the brake lights 32, 34, 36 by line 64 such that the brake lights 32, 34, 36 may be illuminated when the supervisory electronic control unit 22 performs certain high-level braking functions.

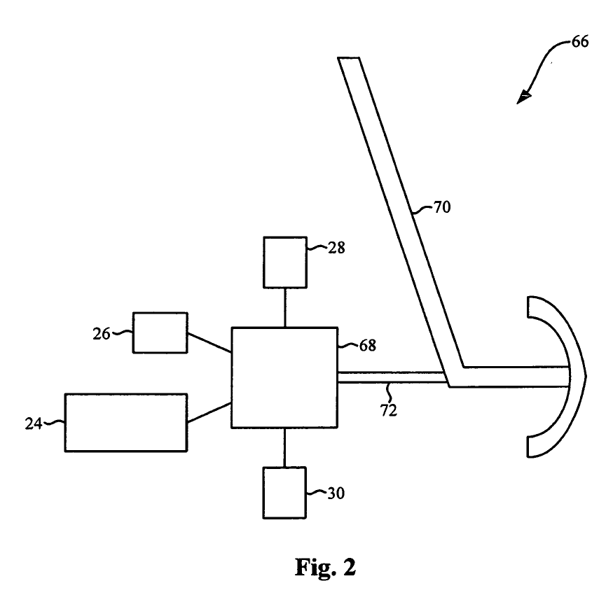

As shown in FIG. 2, the brake switch 24 and brake pedal sensors 26, 28, 30 may be associated with a brake pedal assembly 66. Those skilled in the art will appreciate that two or more brake switches 24 may be used without departing from the scope of the present disclosure. The brake pedal assembly 66 may include a pedal feel emulator 68 and a brake pedal 70 connected to the pedal feel emulator 68 by a mechanical connection 72. The pedal feel emulator 68 may be a damper, a spring or the like adapted to provide resistance when a user depresses the brake pedal 70, thereby emulating the feel of a traditional hydraulic brake system.

The brake switch 24 may monitor movement of the brake pedal 70 to detect whether a user has depressed the brake pedal. As shown in FIG. 1, signals from the brake switch 24 may be directly communicated to the right-front corner brake module 14 over line 74 and left-front corner brake module 12 over line 76. However, those skilled in the art will appreciate that the brake switch 24 may be in direct communication with any one or more of the corner brake modules 12, 14, 16, 18, regardless of whether or not the corner brake module is directly connected to a sensor. Furthermore, like the supervisory electronic control unit 22, the brake switch 24 may be connected to the brake lights 32, 34, 36 by line 64 such that the brake lights 32, 34, 36 may be illuminated when the brake pedal 70 (FIG. 2) is manipulated.

When the brake switch 24 is actuated, and regardless of other inputs to the system 10 or the lack thereof, the corner brake modules 12, 14 that are directly connected to the brake switch 24 may automatically apply a certain predetermined amount of braking force. For example, actuation of the brake switch 24 may initiate an automatic 20 percent brake apply. Furthermore, the automatic brake apply stemming from actuation of the brake switch 24 may be communicated to the other corner brake modules 16, 18 in the system 10 (i.e., those not directly connected to the brake switch 24) in the manner discussed in detail herein.

Accordingly, in the event of a system failure, such as a failure of the communication bus (discussed below), the driver's intent to brake may be detected by the brake switch 24 and directly communicated to at least one corner brake module 12, 14 of the system 10 (i.e., to those corner brake modules that are directly connected to the brake switch 24) despite the system failure, thereby providing the system 10 with a first redundant, fail-safe option.

The park brake switch 25 may initiate a parking brake procedure, similar to a traditional parking brake, wherein one or more of the corner brake modules 12, 14, 16, 18 are electronically actuated. For example, as shown in FIG. 1, signals from the park brake switch 25 may be directly communicated to the right-front corner brake module 14 over line 29 and the left-front corner brake module 12 over line 27. However, those skilled in the art will appreciate that the park brake switch 25 may be in direct communication with any one or more of the corner brake modules 12, 14, 16, 18, regardless of whether or not the corner brake module is directly connected to a sensor. Furthermore, two or more park brake switches 25 may be used without departing from the scope of the present disclosure.

Therefore, when the park brake switch 25 is actuated, and regardless of other inputs to the system 10 or the lack thereof, the corner brake modules 12, 14 that are directly connected to the park brake switch 25 may automatically apply a certain predetermined amount of braking force or undergo a certain predetermined braking routine. For example, actuation of the park brake switch 25 while traveling a 40 miles per hour may initiate a braking routing that arrives at 100 percent brake apply over 5 seconds. Furthermore, the automatic brake routine initiated in response to actuation of the park brake switch 25 may be communicated to the other corner brake modules 16, 18 in the system 10 (i.e., those not directly connected to the park brake switch 25) in the manner discussed in detail herein.

Accordingly, in the event of a system failure, such as a failure of the communication bus, the driver may actuate the park brake switch 25 to initiate an emergency brake routine. The emergency brake routine may be performed by at least those corner brake modules that are directly connected to the park brake switch 25, thereby providing the system 10 with a second redundant, fail-safe option.

The system 10 may include three brake pedal sensors 26, 28, 30, which may be any sensors capable of detecting a driver's braking intent. Three brake pedal sensors 26, 28, 30 may be used in system 10 for redundancy. However, those skilled in the art will appreciate that any number of brake pedal sensors may be used without departing from the scope of the present disclosure. These sensors may be with or without internal redundancy. In order to be single fault tolerant, minimum safety requirements may require at least three basic sensors (i.e., without internal redundancy), or two sensors with internal redundancy (i.e., two fail-safe sensors). Particularly, in the case where both sensor 28 connected to the right-front brake module 14 and sensor 30 connected to the left-front corner module 12 present internal redundancy (i.e., sensors 28 and 30 are fail-silent sensors), the third sensor 26 connected to the supervisory electronic control unit 22 may no longer be necessary.

Brake pedal sensor 26 may be a force sensor, a pedal travel sensor or the like and may communicate sensor signals to the supervisory electronic control unit 22 by a direct connection 90, such as, for example, a single wire analog connection. Brake pedal sensors 28, 30 may be modified brake pedal sensors, such as modified force sensors, modified pedal travel sensors or the like, and may communicate sensor signals directly to the right-front 14 and left-front 12 corner brake modules. However, those skilled in the art will appreciate that alternative architectures may be employed without departing from the scope of the present disclosure. For example, modified sensors 28, 30 may be split front-rear (e.g., sensor 28 may be directly connected to the right-front corner brake module 14 and sensor 30 may be directly connected to the left-rear corner brake module 18) or in a four-corner arrangement.

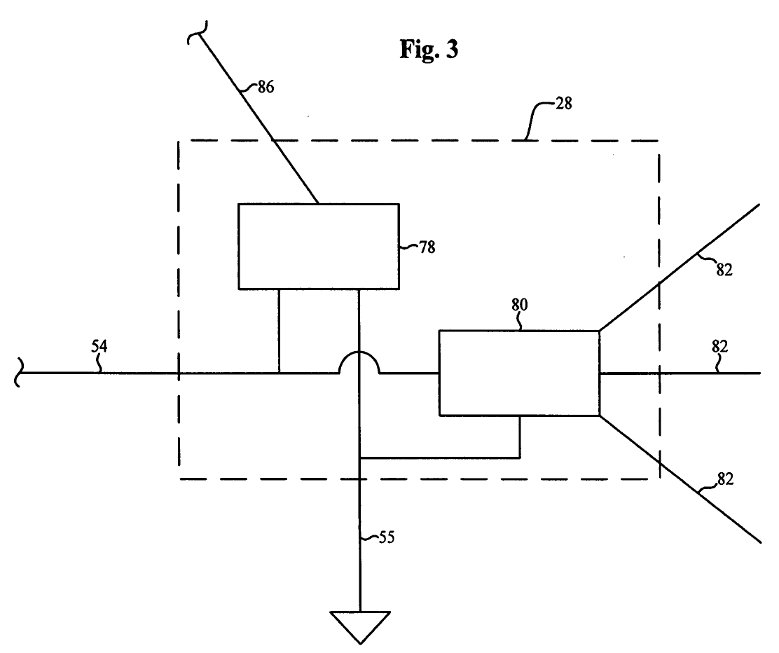

The modified brake pedal sensors 28, 30 may be brake pedal sensors incorporating an integral star coupler. In particular, referring to FIG. 3, sensor 28, like sensor 30, may include sensor electronics 78 and a star coupler 80, each of which may be connected to a power source (line 54) and ground (line 55). The sensor electronics 78 of sensor 28 may be connected to the right-front corner brake module 14 by a direct connection 86, such as, for example, a single wire analog connection.

Thus, the star coupler 80 in sensor 28 may facilitate communication between the left-front corner brake module 12, the right-front corner brake module 14, the right-rear corner brake module 16, the left-rear corner brake module 18, the power distribution box 20 and/or the supervisory electronic control unit 22 over a first channel (shown by solid ray lines 82) of a serial communication bus. Furthermore, as shown in FIG. 1, sensor 30 may be a modified sensor incorporating an integral star coupler and may be connected to the left-front corner brake module 12 by a direct connection 88, such as, for example, a single wire analog connection. Therefore, the star coupler (not shown) of sensor 30 may facilitate communication between the left-front corner brake module 12, the right-front corner brake module 14, the right-rear corner brake module 16, the left-rear corner brake module 18, the power distribution box 20 and/or the supervisory electronic control unit 22 over a second channel (shown by broken ray lines 84) of the serial communication bus.

The serial communication bus may be any communication bus, such as a time-triggered communication bus with partial or complete channel redundancy. The two modified sensors 28, 30 may be used to facilitate communication over two separate channels of a communication bus. However, those skilled in the art will appreciate that any number of modified sensors may be used with system 10 without departing from the scope of the present disclosure. Design considerations, including the quantity and placement of modified sensors, may be driven by the number of available communication bus channels and the desired amount of redundancy.

Accordingly, sensor signals from modified sensor 28 may be directly communicated to the right-front corner brake module 14 by connection 86. If necessary, the right-front corner brake module 14 may perform an analog-to-digital conversion of the sensor signals received from the modified sensor 28. From the right-front corner brake module 14, the sensor signals may then be communicated to the right-rear corner brake module 16, the left-rear corner brake module 18, the left-front corner brake module 12, the power distribution box 20 and the supervisory electronic control unit 22, either over the first channel (solid ray lines 82) of the serial communication bus by way of the star coupler 80 of modified sensor 28 and/or over the second channel (broken ray lines 84) of the serial communication bus by of the star coupler (not shown) of the modified sensor 30.

Furthermore, sensor signals from modified sensor 30 may be directly communicated to the left-front corner brake module 12 by connection 88. If necessary, the left-front corner brake module 12 may perform an analog-to-digital conversion of the sensor signals received from the modified sensor 30. From the left-front corner brake module 12, the sensor signals may then be communicated to the right-front corner brake module 14, the right-rear corner brake module 16, the left-rear corner brake module 18, the power distribution box 20 and the supervisory electronic control unit 22, either over the first channel (solid ray lines 82) of the serial communication bus by way of the star coupler 80 of the modified sensor 28 and/or over the second channel (broken ray lines 84) of the serial communication bus by way of the star coupler (not shown) of modified sensor 30.

Thus, modified sensors 28, 30 facilitate communication of information between all electronic control units in the system 10 and reduces costs by removing the complex, single pedal feel emulator electronic control unit and implementing a distributed E/E architecture using electronic control units already available in traditional brake-by-wire brake systems.

Furthermore, the system 10 enhances several safety points. First, by spatially distributing the driver's intent function and its related electronics on the whole E/E architecture, the residual probability of an occurrence of a spatial proximity fault is reduced. Second, in case of a communication bus loss, one or more of the modified pedal sensors is able to communicate directly with the corner brake modules, thereby reducing the risk of accident.

Although various aspects of the disclosed distributed E/E architectures for brake-by-wire brake systems have been shown and described, modifications may occur to those skilled in the art upon reading the specification. The present application includes such modifications and is limited only by the scope of the claims.

What is claimed is:

1. A brake system comprising:
a communication bus;
a sensor including an integral star coupler, said star coupler being in communication with said communication bus, wherein said sensor generates a sensor signal;
a first electronic control unit directly connected to said sensor to receive said sensor signal, said first electronic control unit being in communication with said communication bus; and
a second electronic control unit in communication with said communication bus, wherein said second electronic control unit receives said sensor signal over said communication bus by way of said star coupler.

2. The brake system of claim 1 wherein said communication bus is a time-triggered communication bus.

3. The brake system of claim 1 wherein said communication bus includes at least a first channel and a second channel.

4. The brake system of claim 3 wherein said star coupler is in communication with said first channel of said communication bus.

5. The brake system of claim 1 wherein said sensor is a brake pedal travel sensor.

6. The brake system of claim 1 wherein said sensor is a brake pedal force sensor.

7. The brake system of claim 1 wherein said first electronic control unit is a vehicle corner brake module.

8. The brake system of claim 7 wherein said vehicle corner brake module includes an electro-mechanical braking device.

9. The brake system of claim 1 wherein said first electronic control unit is a power distribution box.

10. The brake system of claim 1 wherein said first electronic control unit is a supervisory electronic control unit.

11. The brake system of claim 1 wherein said first electronic control unit is any electronic control unit connected to said communication bus.

12. The brake system of claim 1 wherein said first electronic control unit is connected to said sensor by a single wire analog connection.

13. The brake system of claim 1 wherein said second electronic control unit is a vehicle corner brake module.

14. The brake system of claim 1 wherein said second electronic control unit is a power distribution box.

15. The brake system of claim 1 wherein said second electronic control unit is a supervisory electronic control unit.

16. The brake system of claim 1 wherein said second electronic control unit is any electronic control unit connected to said communication bus.

17. The brake system of claim 1 further comprising a second sensor, said second sensor including an integral star coupler.

18. The brake system of claim 1 further comprising a brake pedal, wherein said sensor signal is generated in response to manipulation of said brake pedal.

19. The brake system of claim 18 further comprising a pedal feel emulator connected to said brake pedal.

20. The brake system of claim 1 wherein said first electronic control unit is electrically powered independently of said second electronic control unit.

21. The brake system of claim 1 further comprising a brake switch in direct communication with at least one of said first and said second electronic control units.

22. The brake system of claim 1 further comprising a park brake switch in direct communication with at least one of said first and said second electronic control units.

23. A brake system comprising:
a communication bus, said communication bus including at least a first channel and a second channel;
a first brake pedal sensor including an integral star coupler, said star coupler being in communication with said communication bus by way of said first channel, wherein said first sensor generates a first sensor signal;
a second brake pedal sensor including an integral star coupler, said star coupler being in communication with said communication bus by way of said second channel, wherein said second sensor generates a second sensor signal;
a first electronic control unit directly connected to said first sensor to directly receive said first sensor signal, said first electronic control unit being in communication with said first and said second channels; and
a second electronic control unit directly connected to said second sensor to directly received said second sensor signal, said second electronic control unit being in communication with said first and said second channels,
wherein said first electronic control unit receives said second sensor signal over said first channel by way of said first star coupler and said second channel by way of said second star coupler and wherein said second electronic control unit receives said first sensor signal over said first channel by way of said first star coupler and said second channel by way of said second star coupler.

24. A brake system comprising:
a communication bus, said communication bus including at least a first channel and a second channel;
a plurality of electronic control units, each electronic control unit of said plurality of electronic control units being in communication with said communication bus by way of at least one of said first channel and said second channel;
at least one park brake switch in direct communication with at least one of said plurality of electronic control units;
at least one brake switch in direct communication with at least one of said plurality of electronic control units;
a plurality of sensors, at least one sensor of said plurality of sensors being in direct communication with at least one of said plurality of electronic control units,
wherein said plurality of sensors, said at least one park brake switch and said at least one brake switch provide a set of redundant, fail-safe signals to said plurality of electronic control units.

25. The brake system of claim 24 wherein at least one of said plurality of sensors is a brake pedal sensor.

26. The brake system of claim 24 wherein each of said plurality of electronic control units that receives a signal from one of said plurality of sensors is powered by an independent power line.

27. The brake system of claim 26 wherein said independent power line is supplied by a power distribution box.

28. The brake system of claim 24 wherein a first one of said plurality of electronic control units is in communication with said communication bus by way of said first channel, a second one of said plurality of electronic control units is in communication with said communication bus by way of said second channel, and a third one of said plurality of electronic control units is in communication with said communication bus by way of said first channel and said second channel.

29. The brake system of claim 24 wherein said first channel is implemented by a first star coupler and said second channel is implemented by a second star coupler, said first star coupler being integral with a first one of said plurality of sensors and said second star coupler being integral with a second one of said plurality of sensors.

30. The brake system of claim 29 wherein said first one of said plurality of sensors includes associated conditioning electronics, and wherein said first star coupler is located in said conditioning electronics.

31. The brake system of claim 24 wherein said communication bus includes a plurality of segments, wherein a first one of said plurality of segments includes at least one of said plurality of electronic control units and a second one of said plurality of segments includes at least one of said plurality of electronic control units, and wherein at least one of said plurality of sensors is directly connected to at least one of said electronic control units of said first segment and at least one of said plurality of sensors is directly connected to at least one of said electronic control units of said second segment.

32. The brake system of claim 31 wherein each of said plurality of electronic control units which receives a signal from at least one of said plurality of sensors is on an independent one of said plurality of segments of said communication bus.

33. The brake system of claim 31 being associated with a vehicle and wherein each of said plurality of electronic control units that receive a signal from one of said plurality of sensors are positioned at a unique location of said vehicle.

34. The brake system of claim 24 wherein said communication bus includes a first segment and a second segment, said first segment including a front-right corner brake module and a rear-left corner brake module, said second segment including a front-left corner brake module and a rear-right corner brake module, wherein at least one of said plurality of sensors is directly connected to at least one of said corner brake modules of said first segment, and wherein at least one of said plurality of sensors is directly connected to at least one of said corner brake modules of said second segment.

35. The brake system of claim 24 wherein said communication bus includes a first segment and a second segment, said first segment including a front-right corner brake module and a front-left corner brake module, said second segment including a rear-right corner brake module and a rear-left corner brake module, wherein at least one of said plurality of sensors is directly connected to at least one of said corner brake modules of said first segment, and wherein at least one of said plurality of sensors is directly connected to at least one of said corner brake modules of said second segment.

36. The brake system of claim 24 wherein said at least one brake switch is in direct communication with a first one of said plurality of electronic control units which is in direct communication with a first one of said plurality of sensors, and said at least one park brake switch is in direct communication with a second one of said plurality of electronic control units which is in direct communication with a second one of said plurality of sensors.

37. The brake system of claim 24 being associated with a vehicle, and wherein each of said plurality of electronic control units that receives a signal from at least one of said at least one brake switch and said at least one park brake switch are positioned at a unique location of said vehicle.
